(19) United States
(12) Patent Application Publication
(10) Pub. No.: US 2011/0084546 A1
(43) Pub. Date: Apr. 14, 2011

(54) Bicycle Axle Assembly

(76) Inventor: Dirk Martin Lüde, Bad Wiessee (DE)

(21) Appl. No.: 12/972,031

(22) Filed: Dec. 17, 2010

Related U.S. Application Data
(63) Continuation-in-part of application No. PCT/EP09/04377, filed on Jun. 17, 2009.

(30) Foreign Application Priority Data
Jun. 19, 2008 (DE) 10 2008 029 136.6

(51) Int. Cl. B60B 35/04

(52) U.S. Cl. 301/124.1

(57) ABSTRACT

A bicycle axle assembly includes an axle in the form of a support part for a hub. The axle has a threaded end and a fast-action clamp end. The assembly includes a fast-action clamping device having a clamping axle disposed coaxially with the axle. The bicycle axle assembly has a stop device disposed and formed such that, on clamping the fast-action clamping device, the clamping axle is supported on the axle in the axial direction of the axle.

### CROSS-REFERENCE TO RELATED APPLICATIONS

This is a continuation-in-part application, under 35 U.S.C. §120, of copending international application No. PCT/EP2009/004377, filed Jun. 17, 2009, which designated the United States and was published in English; this application also claims the priority, under 35 U.S.C. §119, of German Patent Application No. 10 2008 029 136.6, filed Jun. 19, 2008; the prior applications are herewith incorporated by reference in their entirety.

### STATEMENT REGARDING FEDERALLY SPONSORED RESEARCH OR DEVELOPMENT

Not applicable.

### FIELD OF THE INVENTION

The invention relates to a bicycle axle assembly having an axle which is formed as a support part for a hub and has a threaded end and a fast-action clamp end, and a fast-action clamping device which has a clamping axle arranged coaxially with the axle. The invention also relates to a combination of a bicycle wheel holder, such as a bicycle fork, a bicycle rocker arm, a bicycle chainstay or another wheel holder having such a bicycle axle assembly.

Such bicycle axle assemblies are known and are used in particular in the case of bicycles with forks for downhill (DH), crosscountry (CC) and freestyle or freeride (FR) use. There, due to the high speeds, considerable unevenness, large jumps, and the necessity of overcoming obstacles, the bicycle axle assembly is subjected to particularly high loads.

In the case of fast-action clamping devices for full-floating axles, it is necessary reliably to prevent the running wheel from falling out if the clamping levers are accidentally opened. For this purpose, as a rule, closed holder ends on the bicycle wheel holder (fork, rocker arm, chainstay, etc) are provided. In the case of bicycle forks, the holder ends are also referred to as dropouts.

U.S. Pat. No. 6,089,675 to Schlanger discloses a bicycle axle assembly having an axle that is formed as a support part for a hub and has a threaded end, a fast-action clamp end, and a fast-action clamping device. The bicycle axle assembly has the disadvantage that the magnitude of the clamping force is determined by the depth to which the threaded end is screwed into the holder end of the fork. The clamping force must, therefore, be reset with each mounting. Presetting of the clamping force is not possible and considerable experience is required to mount the wheel rapidly and reliably.

International Publication WO 2005/120940 A1 to Bartlett discloses a bicycle axle assembly having an axle that is formed as a support part for a hub and has a fast-action clamp end and fast-action clamping device. At the end opposite the fast-action clamp end, the axle has a bayonet-fitting end that can be turned into a corresponding receptacle in the holder end of a fork. This embodiment has the disadvantage that the bayonet fitting is not stable particularly in the case of the high loads occurring during cross-country riding. Moreover, it will be necessary for the pin provided in the holder end to be formed from steel while the fork or the frame is formed from a light metal alloy. Due to the different potentials associated therewith, rapid corrosion will occur particularly under humid weather conditions.

A bicycle axle assembly having an axle which is formed as a support part for a hub and has a threaded end and a fast-action clamp end and a fast-action clamping device which has a clamping axle arranged coaxially with the axle, is known from the full-floating axle system of Rockshox, which system is available under the name Maxle. This full-floating axle system has a full-floating axle with a threaded end. A clamping axle on the end of which a nut is screwed which secures a cone that engages the axle runs in the full-floating axle. The depth of penetration of the cone in the axial direction of the axle is determined by the clamping force of the fast-action clamping device. A cone whose depth of penetration into the axle is likewise determined by the clamping force of the fast-action clamping device is likewise provided on the fast-action clamp end. The ends of the full-floating axle are slotted. On clamping, one cone is drawn in the direction of the other cone. Thus, in each case, a cone that widens the respective end of the full-floating axle is drawn into the two slotted ends of the full-floating axle. The resulting forces are absorbed by the closed holder ends. It is clear that such a system is not suitable for open holder ends because the clamping forces would result in divergence of the open holder end. Particularly during cross-country riding, high forces occur which may then lead to fatigue fractures of the holder ends.

The invention provides a bicycle axle assembly having an axle which is formed as a support part for a hub and has a threaded end and a fast-action clamp end, and a fast-action clamping device that has a clamping axle disposed coaxially with the axle, in which the mounting and dismantling can be carried out easily, rapidly and reliably and, at the same time, high operational safety and stability is ensured, particularly for cross-country riding.

The object of the invention is achieved by a bicycle axle assembly according to the invention. Advantageous configurations of the invention are described in the dependant claims.

One embodiment of the invention provides a bicycle axle assembly having an axle that is formed as a support part for a hub and has a threaded end and a fast-action clamp end, and a fast-action clamping device, which has a clamping axle disposed coaxially with the axle, the bicycle axle assembly having a stop device disposed and formed such that the clamping axle is supported on the axle in the axial direction of the axle on clamping of the fast-action clamping device.

The embodiment according to the invention has the advantage that the forces acting from the bicycle axle assembly on the holder ends during clamping are in the direction of the axle. Divergence of the ends of the axle does not take place, and it is for this reason that it is also possible to use open holder ends. In an exemplary embodiment, one holder end is open and the other holder end is closed. This has the advantage that the axle assembly need only be pushed partly into the hub before the threaded axle end disposed in the closed holder end is freed so that the wheel can be removed from the bicycle.

Advantageously, the stop device can be disposed and formed such that the clamping force exerted by the fast-action clamping device is preset. The presetting of the clamping force can be effected by adjusting the relative position of the stops of the stop device in the direction of the axle. This can be effected during production. Alternatively and preferably, the length of the clamping axle is adjustable such that the position of the stop provided on the clamping axle and, hence, the clamping force are adjustable. For this purpose, the clamping axle can be formed, for example, in at least two parts. For example, the clamping axle may have an adjusting nut which is screwed onto a clamping axle section. The head of the adjusting nut may be formed as a stop of the stop device, which stop cooperates with a corresponding axle stop of the axle. According to a further development of the invention, the adjusting nut may be a self-locking adjusting nut in order to prevent unintentional misadjustment. Alternatively, the adjusting nut may also be secured in its axial position by means of a lock nut.

According to the invention, the stop device may have an axle stop formed on the axle. The axle stop may have a flange projecting on the inside of the axle. Furthermore, the stop device may have a clamping axle stop formed on the clamping axle. Preferably, the clamping axle stop may have a flange projecting on the outside of the clamping axle.

According to the invention, the clamping axle may have a flange projecting on the outside of the clamping axle.

According to the invention, the clamping axle may be formed to be adjustable in length. This embodiment of the invention has the advantage that the clamping force of the fast-action clamping device can be adjusted.

According to the invention, the clamping axle may be formed in at least two parts.

According to the invention, the clamping axle may have an adjusting nut that is screwed onto an axle section of the clamping axle. Advantageously, the adjusting nut may have the clamping axle stop of the stop device. In an exemplary embodiment, the adjusting nut may have a threaded blind hole. This has the advantage that the adjustment of the clamping force is limited. Alternatively or additionally, the limitation of the adjustability of the clamping force can be effected by the length of the thread on the clamping axle section. Alternatively or additionally, it is also possible to provide, on the clamping axle section, a collar that limits the adjustability of the adjusting nut by its stop.

According to the invention, the clamping axle can be disposed to be non-rotatable relative to the axle. This embodiment has the advantage that the axle can be screwed into the closed holder end by rotation of the clamping lever of the fast-action clamping device, because the clamping lever is formed so as to be non-rotatable relative to the clamping axle and, according to the embodiment, the latter is formed so as to be non-rotatable relative to the axle.

According to the invention, the axle may have a rotation prevention section and the clamping axle may have a rotation prevention section that cooperates with the rotation prevention section of the axle. The rotation prevention section of the axle may have a polygon socket profile and/or an internal multi-tooth profile, and the rotation prevention section of the clamping axle may have an external polygon profile and/or external multi-tooth profile.

According to the invention, the threaded end of the axle may comprise an external thread.

According to the invention, the bicycle axle assembly may have a threaded bushing that can be inserted into a closed holder end of a bicycle wheel holder and has a threaded section for engaging the threaded end of the axle. The threaded bushing may have a multi-tooth profile or polygon profile which is formed such that the threaded bushing can be disposed in a correspondingly formed recess of a holder end.

According to the invention, the bicycle axle assembly may have a hub, which is disposed on the axle, and a loss prevention device that places the axle in the hub in a captive manner, the loss-prevention device, in an exemplary embodiment, being disposed in a cavity formed between the hub and the axle, and the loss prevention device, in an exemplary embodiment, being formed in particular from one or more O-rings disposed on the axle.

According to the invention, the bicycle axle assembly may have a spring device that prestresses the axle in the direction of the fast-action clamping end of the axle. A spring device may be disposed between the hub and the loss prevention device.

According to the invention, the bicycle axle assembly may have a spring device that prestresses the thrust piece of the fast-action clamping device from the axle in the direction of the fast-action clamping end of the axle.

According to an embodiment of the invention, a bicycle wheel axle holder having a bicycle axle assembly according to the invention and two holder ends for holding the axle is also provided, one holder end being in the form of a closed holder end and the other holder end being in the form of an open holder end.

According to the invention, the closed holder end or dropout may have an internal thread for receiving one end of the bicycle wheel axle.

According to the invention, an insertion piece can be held non-rotatably in the closed holder end or dropout, the prevention of rotation being realized, in an exemplary embodiment, through multi-tooth profiles. This embodiment has the advantage that the position of the fast-action clamp lever is preadjustable. Alternatively, the closed end may also be formed by an insertion piece, i.e., the bicycle axle holder may have, according to the invention, two open holder ends or dropouts, one of the two holder ends or dropouts being formed as a closed end by providing an insertion piece.

According to the invention, the insertion piece may be a threaded bushing that is, in an exemplary embodiment, secured by a bolt and/or a screw. The threaded bushing can be provided with a scale that indicates the position of the clamping lever when the axle is completely screwed in.

According to the invention, the closed holder end or dropout (and/or the open holder end or dropout) may have a stop for the hub of the bicycle wheel. This embodiment has the advantage that a defined position is permitted on installation of the wheel in the bicycle axle holder, thus making it possible to install the running wheel with one hand so that the other hand can hold the bicycle.

According to the invention, the open holder end or dropout (and/or the closed holder end or dropout) may have a countersink.

According to the invention, the bicycle wheel axle holder may be part of a bicycle fork, part of a bicycle rocker arm, and/or part of a bicycle chainstay.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages all in accordance with the present invention. Advantages of embodiments of the present invention will be apparent from the following detailed description of the exemplary embodiments thereof, which description should be considered in conjunction with the accompanying drawings in which:

FIG. 1 is a cross-sectional view of a bicycle axle assembly according to an embodiment of the invention with a bicycle fork shown schematically and shortened;

FIG. 2 is a fragmentary cross-sectional view of the bicycle axle assembly of FIG. 1 along the section line II-II of FIG. 1;

FIG. 3 is a fragmentary, cross-sectional view of the bicycle axle assembly of FIG. 1 along the section line III-III of FIG. 1; and

FIG. 4 is a perspective view of the bicycle fork of FIG. 1 shown schematically and shortened.

### DETAILED DESCRIPTION OF THE INVENTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

Alternate embodiments may be devised without departing from the spirit or the scope of the invention. Additionally, well-known elements of exemplary embodiments of the invention will not be described in detail or will be omitted so as not to obscure the relevant details of the invention.

Before the present invention is disclosed and described, it is to be understood that the terminology used herein is for the purpose of describing particular embodiments only and is not intended to be limiting. The terms “a” or “an”, as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

Relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

Herein various embodiments of the present invention are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

The following reference numerals are used in the description of the examples set forth herein:
10 Bicycle wheel holder
11 Holder end (closed)
12 Holder end (open)
13 Passage
14 Open bore
15 Stop for hub
16 Countersink (stop and holder for thrust piece 51)
17 Multi-tooth profile (for threaded bushing)
18 End face (of the countersink 16)
20 Threaded bushing (insertion piece for axle holder)
21 Internal thread
22 Extension
23 Flange
24 Bolt (or screw and/or pin)
27 Multi-tooth profile
30 Axle
31 Threaded end (with external thread)
32 Flange (end face forms the axle stop)
33 Cylinder section
34 Rotation prevention section
35 Hexagon socket profile
36 Loss prevention device
37 Fast-action clamp end
40 Clamping axle
41 Adjusting nut (part of the clamping axle, the head forms the clamping axle stop)
42 Threaded section
43 Axle section
44 Rotation prevention section
45 External hexagon profile
50 Fast-action clamp
51 Thrust piece
52 Cam bearing
53 Pin
54 Eccentric cam
55 Clamping pin
56 Clamping lever
60 Hub
61 Bearing section (ball bearing not shown)
62 Bearing section (ball bearing not shown)
63 Cylinder section
64 Cavity
65 Stop (for loss prevention means)
66 Stop (for spring device)
70 Spring device (helical spring)

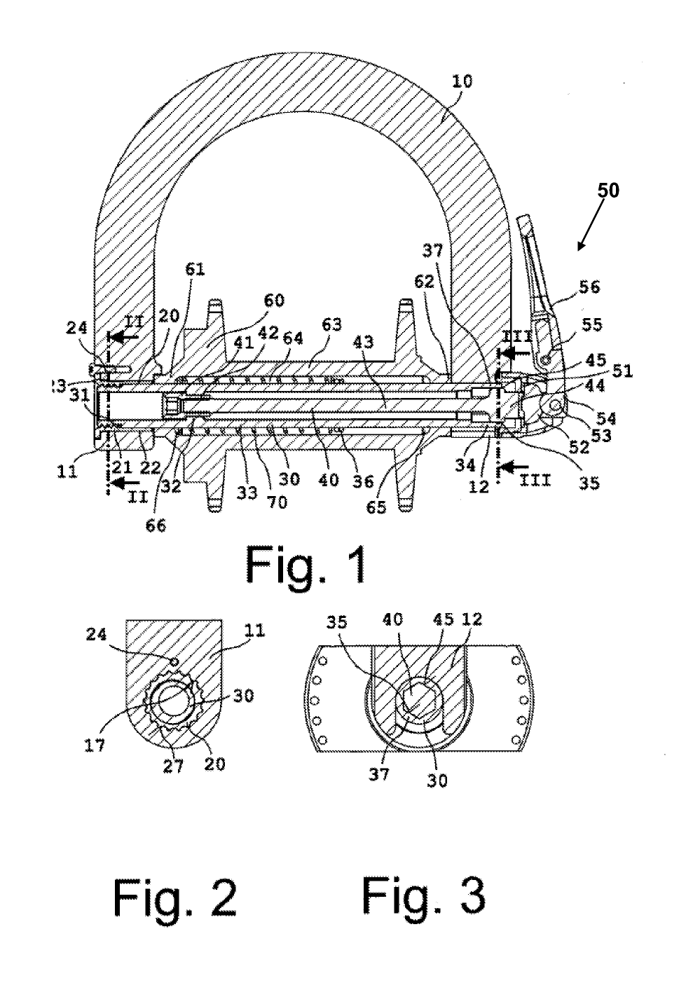

Described now are exemplary embodiments of the present invention. Referring now to the figures of the drawings in detail and first, particularly to FIG. 1, there is shown a first exemplary embodiment of a sectional view of a bicycle axle assembly according to the invention with a bicycle fork 10 (generally, a bicycle wheel holder) shown schematically and shortened. The bicycle axle assembly according to the invention may also be disposed in another bicycle wheel holder with holder ends or dropouts, such as, for example, a rocker arm or a chainstay.

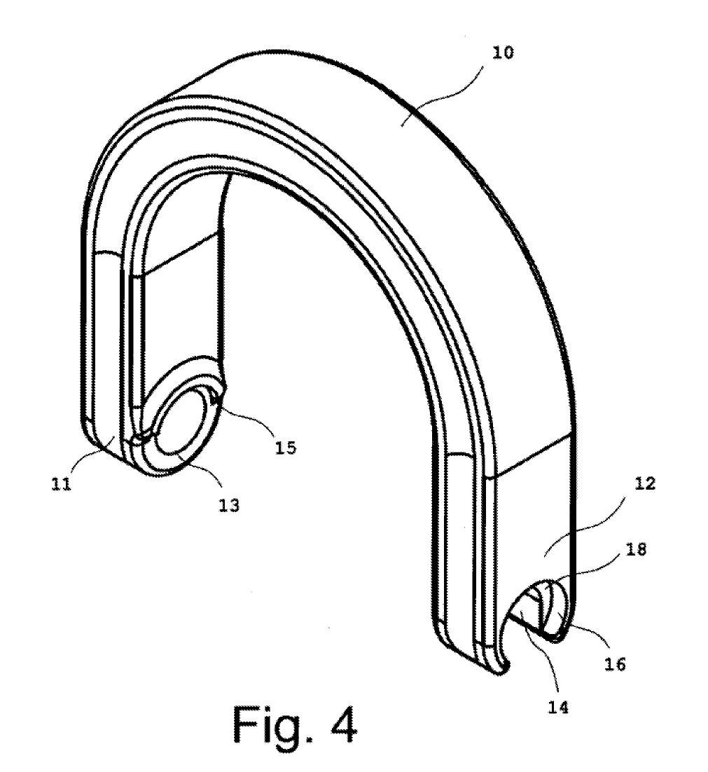

The bicycle wheel holder 10 has a closed holder end 11 and an open holder end 12. As can best be seen in FIG. 4, the closed holder end 11 has a passage 13 with a stop 15 for the hub which is not shown in FIG. 4. The open holder end 12 has an open bore 14 that is provided with a countersink 16 which serves as a stop and holder for the thrust piece 51.

As can be best seen in FIG. 2, a multi-tooth profile 17 for captive retention of a threaded bushing 20 is provided in the passage 13. The threaded bushing 20 has, on its outside, a corresponding multi-tooth profile 27. The threaded bushing 20 has an internal thread 21 into which the threaded end 31 of the axle 30 can be screwed.

According to an alternative embodiment not shown, the threaded end 31 of the axle 30 may also be screwed directly into an internal thread provided in the passage of the holder end.

According to an embodiment of the invention that is not shown, the threaded bushing may also have, for example, a central extension with an external thread onto which it is possible to screw the threaded end of an axle, which threaded end has an internal thread.

The threaded bushing 20 has a cylindrical extension 22 that serves for guiding the threaded end 31 of the axle 30 during mounting.

The threaded bushing 30 furthermore has a flange 23 with which the threaded bushing 20 is supported on the end face of the holder end 11 of the bicycle wheel holder 10 during clamping of the fast-action clamping device. A bolt 24 is provided for securing the threaded bushing 20. Alternatively or additionally, a screw and/or a pin can also be provided.

Once again with reference to FIG. 1, the axle 30 has a threaded end 31 having an external thread. The fast-action clamp end 37, on which a rotation prevention section 34 is provided, is located at the opposite end of the axle 30. The threaded end 31 is connected to the rotation prevention section 34 through a cylinder section 33. A flange 32 whose end face forms the axle stop of the stop device is provided on the inside of the cylinder section 33.

Within the axle 30, a clamping axle 40 is provided coaxially with the axle 30. The clamping axle 40 has an axle section 43 and an adjusting nut 41. The head of the adjusting nut 41 forms the clamping axle stop that cooperates with the axle stop of the flange 32 as the stop device.

The adjusting nut 41 forms the end of the clamping axle 40. The head of the adjusting nut 41 thus forms a flange that projects on the outside of the clamping axle and accounts for the clamping axle section of the stop device.

The adjusting nut 41 is connected to the axle section 43 of the clamping axle 40 by a threaded section 42. The clamping axle 40 is, thus, adjustable in length by disposing the adjusting nut 41 in a desired position on the threaded section 42 by turning the adjusting nut 41.

The adjusting nut 41 has, in its head, an engaging device for a tool by which the adjusting nut 41 can be turned. For example, an engaging device for a hexagon socket key is provided in the head of the adjusting nut 41.

By adjusting the length of the clamping axle, it is possible to set the position from when the stop device engages the fast-action clamping device during clamping and builds up a clamping force. As a result of the adjustability of the length of the clamping axle, it is therefore possible for the clamping force of the fast-action clamping device to be adjusted.

The clamping axle 40 is formed in at least two parts because the clamping axle comprises at least the adjusting nut 41 and the axle section 43.

In the embodiment shown, the adjusting nut 41 has a threaded blind hole. This has the advantage of effecting a limitation of the adjustment of the clamping force. Alternatively or additionally, the limitation of the adjustability of the clamping force can be effected by the length of the threaded section 42. Alternatively or additionally, the axle section 43 can be provided with a collar that limits the adjustability of the adjusting nut 41, and is shown in FIG. 1.

As is best seen in FIG. 4, the axle 30 is disposed non-rotatably relative to the clamping axle 40. The axle 30 has a rotation prevention section 34 that cooperates as a rotation prevention device with a rotation prevention section 44 of the clamping axle 40. In the embodiment shown, the rotation prevention section 34 has a hexagon socket profile 35 that engages an external hexagon profile 45 of the clamping axle.

Once again with reference to FIG. 1, the bicycle axle assembly has a fast-action clamp 50. The fast-action clamping device comprises the clamping axle 40 and the fast-action clamp 50. The fast-action clamp 50 has a thrust piece 51 disposed in a countersink 16 that is formed in the open holder end 12 and can best be seen in FIG. 4. The end face 18 of the countersink 16 forms a stop for the thrust piece 51. In the clamped state, the thrust piece 51 is supported on the end face 18 of the countersink 16. In the released state, the thrust piece 51, due to its diameter which is greater than the external diameter of the axle 30 (the external diameter of the axle substantially corresponds to the internal clearance of the opening of the open holder end 12), secures the wheel to prevent it from falling out because, in the released state of the fast-action clamping device, the thrust piece 51 does not project completely out of the countersink 16 and is supported on the circumferential wall of the countersink 16.

The fast-action clamp 50 has a cam bearing 52 on which an eccentric cam 54 is supported through a pin 53. A clamping lever 56 is fixed to the eccentric cam 54 through a clamping pin 55.

The working example shown in FIGS. 1 to 4 comprises the axle 30 with the fast-action clamping device. FIGS. 1 to 4 furthermore show a hub 60. It is clear that, according to the invention, the bicycle axle assembly can comprise the hub 60. Of course, the bicycle axle assembly according to the invention can also be used with other commercially available hubs without departing from the scope of protection of the invention, because the bicycle axle assembly is also marketable without a hub.

The hub 60 has in each case a bearing section 61 and 62 on both sides. Usually, the hub 60 is mounted on the axle 30 by ball bearings. In the figures, the ball bearings are not shown. A cylinder section 63 that, together with the surface of the axle 30, defines a cavity 64 extending between the bearing sections 61, 62.

In the working example shown in FIGS. 1 to 4, a loss prevention device 36 in the form of two O-rings disposed in the cavity on the axle 30 is provided.

Furthermore, a spring device 70 that prestresses the axle in the direction of the clamping lever end, i.e., away from the closed holder end 11, is disposed in the cavity.

A stop 65 for the loss prevention device 36 is provided on an axial end and a stop 66 for the spring device 70 is provided on the other end of the cavity 64. The spring device 70 is disposed between the stop 66 and the loss prevention device 36.

The assembly of the spring device 70, which is in the form of a pressure spring, between the stop 66 and the loss prevention device 36 has the advantage that, after opening of the fast-action clamp 50 and the unscrewing of the axle 30 from the closed holder end 11, the axle 30 inside the hub 60 is pressed by the spring device 70 into a certain position, i.e., a position in which the loss prevention device 36 rests against the stop 65. The axle 30 thus acquires an end position in the hub 60 so that, during installation and removal of the running wheel, it is possible to concentrate on the introduction of the hub 60 and of the brake (not shown), because the axle 30 is on the other side and not in the way. In order to screw in the axle again, the axle 30 has to be screwed in to the threaded bushing against the force of the spring device 70 with the threaded end 31.

Below, the removal and the installation of a running wheel with a bicycle axle assembly according to the invention is described.

First, the fast-action clamp 50 is released by loosening the clamping lever 56. The axle 30 is unscrewed from the threaded bushing 20 disposed in the closed holder end 11 by turning the clamping lever about the axis of the axle 30. As a result, the thrust piece 51 is moved out of the countersink 16 in the open holder end 12 such that the running wheel can be removed downwards from the bicycle wheel holder because the axle 30 fits through the holder end 12 open at the bottom. The spring device 70 and the loss prevention device 36 ensure that the axle 30 remains in its end position in the hub, in which the loss prevention device 36 rests against the stop 65.

Installation is effected in the reverse order. During installation, the axle 30 is not in the way because it is pressed into an end position by the spring device 70. The stop 15 facilitates the positioning of the running wheel at the closed holder end 11 because the hub 60 can be positioned against the stop 15, with the result that the axle 30 is positioned in front of the threaded bushing 20 in such a way that it can easily be screwed therein. On the other side, the correct positioning of the running wheel is achieved by the stop of the axle 30 on the wall of the open bore 14 of the open holder end 12. The running wheel can, thus, easily be inserted and correctly positioned. In contrast to the bicycle axle assemblies known in the prior art, mounting can be effected with one hand, i.e., the bicycle can be held with one hand and the running wheel can be disposed and correctly positioned, for example in the fork, with the other hand, one handedly, so that the fixing of the running wheel after assembly and correct positioning in the fork can be effected by simply screwing the axle 30 into the threaded bushing 20, i.e., the axle 30 is screwed by the clamping lever 56 into the threaded bushing 20 up to the stop. According to a presetting effected at the factory, the clamping lever 56 is automatically in the correct desired position for tightening. The rotational position of the clamping lever 56 at the stop is in fact established by the relative position of the threaded bushing 20 in the closed dropout 11. With the aid of the multi-tooth profile, the desired position of the clamping lever can be set at the factory because it no longer changes later on.

The setting of the desired clamping force is effected by the adjusting nut 41. By turning the adjusting nut 41 on the threaded section 42, the length of the clamping axle 40 is changed. The clamping force can, therefore, be set independently of the rotational position of the clamping lever 56 in its end position, and it is for this reason that the factory presetting is possible through the position of the threaded bushing 20.

Moreover, the desired clamping force can be set once because the setting is not changed on installation and removal of the running wheel. Since the clamping axle 40 is moreover disposed non-rotatably in the axle 30, there is also no danger that locking devices or other securing devices of the settings will accidentally become loose. Correct setting of the clamping force is, therefore, ensured even on repeated installation and removal of the running wheel.

Finally, the clamping lever 56 can be shifted. Mounting is very simple because it is possible to concentrate on the installation of the running wheel as a result of the presetting of the clamping force and of the clamping lever position.

It is clear that alternatives and equivalent solutions obvious to the person skilled in the art on studying the documents should also be within the scope of protection of the present application. For example, alternative assemblies of the spring device are conceivable. For example, the spring device could prestress the clamping axle 40 relative to the axle 30 and/or the thrust piece 51 relative to the axle 30 and/or the open holder end.

The foregoing description and accompanying drawings illustrate the principles, exemplary embodiments, and modes of operation of the invention. However, the invention should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A bicycle axle assembly, comprising:
an axle formed as a support part for a hub, the axle defining an axial direction and having a threaded end and a fast-action clamp end;
a fast-action clamping device having a clamping axle disposed coaxially with the axle;
a stop device disposed and formed such that, on clamping the fast-action clamping device, the clamping axle is supported on the axle in the axial direction of the axle.

2. The bicycle axle assembly according to claim 1, wherein the stop device has an axle stop formed on the axle.

3. The bicycle axle assembly according to claim 2, wherein:
the axle has an inside; and
the axle stop has a flange projecting on the inside of the axle.

4. The bicycle axle assembly according to claim 1, wherein the stop device has a clamping axle stop formed on the clamping axle.

5. The bicycle axle assembly according to claim 4, wherein:
the clamping axle has an outside; and
the clamping axle stop has a flange projecting on the outside of the clamping axle.

6. The bicycle axle assembly according to claim 1, wherein:
the clamping axle has an outside; and
the clamping axle stop has a flange projecting on the outside of the clamping axle.

7. The bicycle axle assembly according to claim 1, wherein the clamping axle is adjustable in length.

8. The bicycle axle assembly according to claim 1, wherein the clamping axle is formed in at least two parts.

9. The bicycle axle assembly according to claim 1, wherein:
the clamping axle has an axle section; and
the clamping axle has an adjusting nut operable to screwed onto the axle section of the clamping axle.

10. The bicycle axle assembly according to claim 9, wherein the adjusting nut has a threaded blind hole.

11. The bicycle axle assembly according to claim 1, wherein the clamping axle is non-rotatable with respect to the axle.

12. The bicycle axle assembly according to claim 1, wherein:
the axle has a rotation prevention section; and
the clamping axle has a rotation prevention section cooperating with the rotation prevention section of the axle.

13. The bicycle axle assembly according to claim 12, wherein:
the rotation prevention section of the axle has at least one of a polygon socket and an internal multi-tooth profile; and
the rotation prevention section of the clamping axle has at least one of an external polygon and an external multi-tooth profile.

14. The bicycle axle assembly according to claim 1, wherein the threaded end of the axle comprises an external thread.

15. The bicycle axle assembly according to claim 1, further comprising a threaded bushing:
being shaped to be inserted into a closed holder end of a bicycle wheel holder; and
having a threaded section operable to engage the threaded end of the axle.

16. The bicycle axle assembly according to claim 15, wherein the threaded bushing has at least one of a multi-tooth profile and polygonal profile that is formed to dispose the threaded bushing in a correspondingly formed recess of a holder end of a bicycle wheel holder.

17. The bicycle axle assembly according to claim 1, further comprising:
a hub disposed on the axle; and
a loss prevention device that disposes the axle in the hub in a captive manner.

18. The bicycle axle assembly according to claim 17, wherein:
the hub and the axle defining a cavity therebetween; and
the loss prevention is disposed in the cavity.

19. The bicycle axle assembly according to claim 18, wherein the loss prevention device is at least one O-ring on the axle.

20. The bicycle axle assembly according to claim 1, further comprising a spring device operable to prestress the axle in a direction of the fast-action clamp end of the axle.

21. The bicycle axle assembly according to claim 20, further comprising:
a hub disposed on the axle;
a loss prevention device that disposes the axle in the hub in a captive manner, the spring device being disposed between the hub and the loss prevention device.

22. The bicycle axle assembly according to claim 1, wherein the fast-action clamping device has a thrust piece, and further comprising a spring device operable to prestress the thrust piece from the axle in a direction of the fast-action clamp end of the axle.

23. The bicycle axle assembly according to claim 1, further comprising a bicycle wheel axle holder having two holder ends shaped and operable to hold the axle, a first of the holder ends being a closed holder end and a second of the holder ends being an open holder end.

24. The bicycle axle assembly according to claim 23, wherein the closed holder end has an internal thread for receiving an end of the axle.

25. The bicycle axle assembly according to claim 23, further comprising an insertion piece held in a non-rotatable manner in the closed holder end by at least one of multi-tooth profiles and polygon profiles.

26. The bicycle axle assembly according to claim 25, wherein the insertion piece is a threaded bushing.

27. The bicycle axle assembly according to claim 26, wherein the threaded bushing is secured by at least one of a bolt and a screw.

28. The bicycle axle assembly according to claim 23, wherein:
a hub is disposed on the axle; and
at least one of the closed holder end and the open holder end has a stop for the hub.

29. The bicycle axle assembly according to claim 23, wherein at least one of the open holder end and the closed holder end has a countersink.

30. The bicycle axle assembly according to claim 23, wherein the bicycle wheel axle holder is part of one of a bicycle fork, a bicycle rocker arm, and a bicycle chainstay.
